(19) United States
(12) Patent Application Publication
(10) Pub. No.: US 2017/0208345 A1
(43) Pub. Date: Jul. 20, 2017

(54) METHOD AND APPARATUS FOR FALSE CONTOUR DETECTION AND REMOVAL FOR VIDEO CODING

(71) Applicant: ELECTRONICS AND TELECOMMUNICATIONS RESEARCH INSTITUTE, Daejeon (KR)

(72) Inventors: Se Yoon JEONG, Daejeon (KR); Hui Yong KIM, Daejeon (KR); Jong Ho KIM, Daejeon (KR); Sung Chang LIM, Daejeon (KR); Jin Soo CHOI, Daejeon (KR); C. C. Jay KUO, Los Angeles, CA (US); Qin HUANG, Los Angeles, CA (US)

(73) Assignee: ELECTRONICS AND TELECOMMUNICATIONS RESEARCH INSTITUTE, Daejeon (KR)

(21) Appl. No.: 15/400,326

(22) Filed: Jan. 6, 2017

(30) Foreign Application Priority Data
Jan. 20, 2016 (KR) 10-2016-0007046

(51) Int. Cl. H04N 19/86; H04N 19/44; H04N 19/17; H04N 19/70

(52) U.S. Cl. CPC H04N 19/86; H04N 19/70; H04N 19/44; H04N 19/17

(57) ABSTRACT

A method and apparatus for false contour detection and removal for video coding are disclosed. The method includes performing false contour detection by detecting a map of false contour candidate pixels from input image data through sequential evolution of a step of acquiring false contour candidate pixels based on each of a plurality of features of a human visual system in a manner that decreases the number of pixels to be detected in each sequential step, and performing false contour removal by removing a false contour in the input image data according to the map of false contour candidate pixels.

### CROSS-REFERENCE TO RELATED APPLICATIONS

This application claims the benefit of Korean Patent Application No. 10-2016-0007046, filed on Jan. 20, 2016, which is hereby incorporated by reference as if fully set forth herein.

### BACKGROUND

Technical Field

The present disclosure relates to video data compression, and more particularly, to a method and apparatus for false contour detection and removal, which accurately determine the position of a false contour and remove the false contour based on the determined position, while not damaging the details of a video itself, through post-processing during video decoding.

Related Art

A contour-like artifact, which is generated by images and video data compression and displayed on a display screen, is called a false contour or pseudo contour. The false contour is often observed in smooth regions of a decoded image. Although the state-of-the-art video compression standard, High Efficiency Video Coding (HEVC) has greatly improved compression performance, compared to the previous standard, Advanced Video Coding (AVC), false contour artifacts still occur in HEVC decoded images. Particularly, when a video is viewed on a display with a large screen size, false contour artifacts are perceived as relatively dominant, thereby remarkably degrading a video perception quality. Therefore, a method for effectively removing a false contour artifact is very important in actual video applications.

A false contour removal method is divided largely into two steps: false contour detection and false contour removal. A big problem with a conventional false contour removal method is that the position of a false contour is not detected accurately. Particularly, a false contour should be distinguished from a real contour, which is not done well in the conventional false contour removal method. In the false contour removal step, a false contour is removed generally using low-pass filtering. As a result, detailed information of a video is damaged.

### SUMMARY

An aspect of the present disclosure is to address at least the above-mentioned problems and/or disadvantages and to provide at least the advantages described below. Accordingly, an aspect of the present disclosure is to provide a method and apparatus for false contour detection and removal for video coding, which determine the position of a false contour based on features of a human visual system regarding the false contour, and particularly, which use evolution of a false contour map to sequentially apply the features, not at one time and thus increase the accuracy of determining the position of the false contour, in post-processing during video decoding.

Another aspect of the present disclosure is to provide a method and apparatus for false contour detection and removal for video coding, which remove a false contour by a visual masking effect, not low-pass filtering, apply probabilistic dithering for the false contour removal, and additionally apply averaging filtering only to a dithered part to eliminate random noise generated during probabilistic dithering.

The embodiments contemplated by the present disclosure are not limited to the foregoing descriptions, and additional embodiments will become apparent to those having ordinary skill in the pertinent art to the present disclosure based upon the following descriptions.

In an aspect of the present disclosure, a method for processing a false contour in a video-compressed image processing apparatus includes performing false contour detection by detecting a map of false contour candidate pixels from input image data through sequential evolution of a step of acquiring false contour candidate pixels based on each of a plurality of features of a human visual system in a manner that decreases the number of pixels to be detected in each sequential step, and performing false contour removal by removing a false contour in the input image data according to the map of false contour candidate pixels.

The false contour detection may sequentially include removal of a very smooth region, exclusion of a texture and edge region, and exclusion of a region without monotonicity.

The false contour detection may include calculating pixel gradient values of each pixel of the input image data with respect to predetermined adjacent pixels around the pixel, determining a very smooth region based on the pixel gradient values, and generating a first False Contour Candidate Map (FCCM) having pixel mapping values to exclude pixels of the very smooth region.

The false contour detection may further include calculating pixel gradient values of pixels of a region other than the very smooth region with respect to predetermined adjacent pixels around the pixels, using the first FCCM, determining whether the region is a texture or edge region based on the pixel gradient values, and generating a second FCCM having pixel mapping values to exclude pixels of the texture or edge region.

To determine whether the region is a texture or edge region, pixel gradient values may be calculated by adding differences between a pixel value of a target pixel and pixel values at both sides of the target pixel in the same line in a plurality of directions, and if a maximum of the pixel gradient values in the plurality of directions is larger than a threshold, and a sum of the pixel gradient values is larger than a threshold, it may be determined that the region is a texture or edge region.

The false contour detection may further include determining for each of pixels of a region other than the texture or edge region whether the pixel is at a position with a monotonic increase or decrease of pixel values, using the second FCCM, and generating a third FCCM having pixel mapping values to exclude pixels of a region without monotonicity.

When it is determined whether a pixel is at a position with a monotonic increase or decrease of pixel values, if the number of adjacent pixel pairs having the same pixel gradient value with respect to a target pixel along a contour direction is less than a first threshold, and the number of adjacent pixel pairs having the same pixel gradient value with respect to the target pixel along a normal direction perpendicular to the contour direction is less than a second threshold, it is determined that the target pixel is in the region without monotonicity.

The false contour removal may include removing monotonicity by probabilistic dithering of pixels of a region with monotonicity generated during the false contour detection.

The false contour removal may include generating video data without dithering noise by applying averaging filtering only to the dithered pixels in image data.

For each of the pixels of the region with monotonicity in the input image data, values within a first window or values within a second window may be replaced with a value selected randomly from pixel values of pixels that do not belong to a texture or edge among the pixels of the region, during the probabilistic dithering, wherein the first window includes at least one pixel located in a first normal direction on a basis of a target pixel, and the second window includes at least one pixel located in a second normal direction on the basis of the target pixel, wherein the second normal direction is opposite direction of the first normal direction.

In an aspect of the present disclosure, an apparatus for processing a false contour in a compressed image includes a false contour detector for detecting a map of false contour candidate pixels from input image data through sequential evolution of a step of acquiring false contour candidate pixels based on each of a plurality of features of a human visual system in a manner that decreases the number of pixels to be detected in each sequential step, and a false contour remover for removing a false contour in the input image data according to the map of false contour candidate pixels.

The false contour detector may sequentially perform removal of a very smooth region, exclusion of a texture and edge region, and exclusion of a region without monotonicity.

The false contour detector may calculate pixel gradient values of each pixel of the input image data with respect to predetermined adjacent pixels around the pixel, determine a very smooth region based on the pixel gradient values, and generate a first False Contour Candidate Map (FCCM) having pixel mapping values to exclude pixels of the very smooth region.

The false contour detector may calculate pixel gradient values of pixels of a region other than the very smooth region with respect to predetermined adjacent pixels around the pixels, using the first FCCM, determine whether the region is a texture or edge region based on the pixel gradient values, and generate a second FCCM having pixel mapping values to exclude pixels of the texture or edge region.

The false contour detector may calculate pixel gradient values by adding differences between a pixel value of a target pixel and pixel values at both sides of the target pixel in the same line in a plurality of directions, and if a maximum of the pixel gradient values in the plurality of directions is larger than a threshold, and a sum of the pixel gradient values is larger than a threshold, may determine that the region is a texture or edge region.

The false contour detector may determine for each of pixels of a region other than the texture or edge region whether the pixel is at a position with a monotonic increase or decrease of pixel values, using the second FCCM, and generate a third FCCM having pixel mapping values to exclude pixels of a region without monotonicity.

When determining whether a pixel is at a position with a monotonic increase or decrease of pixel values, if the number of adjacent pixel pairs having the same pixel gradient value with respect to a target pixel along a contour direction is less than a first threshold, and the number of adjacent pixel pairs having the same pixel gradient value with respect to the target pixel along a normal direction perpendicular to the contour direction is less than a second threshold, the false contour detector may determine that the target pixel is in the region without monotonicity.

The false contour remover may remove monotonicity by probabilistic dithering of pixels of a region with monotonicity generated during the false contour detection.

The false contour remover may generate video data without dithering noise by applying averaging filtering only to the dithered pixels in image data.

For each of the pixels of the region with monotonicity in the input image data, the false contour remover may replace values within a first window or values within a second window with a value selected randomly from pixel values of pixels that do not belong to a texture or edge among the pixels of the region, during the probabilistic dithering, wherein the first window includes at least one pixel located in a first normal direction on a basis of a target pixel, and the second window includes at least one pixel located in a second normal direction on the basis of the target pixel, wherein the second normal direction is opposite direction of the first normal direction.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a view depicting a contour direction and a direction perpendicular to a contour (i.e., a normal direction) in a general local support region;

FIG. 2 is a view depicting an exemplary method for identifying a pixel on a false contour, using an average pixel value of a region divided from a local support region;

FIG. 3 is a view depicting a smooth region of a general real contour;

FIG. 4 is a block diagram of an apparatus for false contour detection and removal according to an embodiment of the present disclosure;

FIG. 5 is a view depicting a method for false contour detection and removal according to an embodiment of the present disclosure;

FIG. 6 is a view depicting the position of a current pixel, pixel 0 and the positions of adjacent pixels, pixel 1 to pixel 8 for use in identifying a very smooth region according to an embodiment of the present disclosure;

FIG. 7 is a view depicting a current pixel and adjacent pixel pairs, for use in identifying a very smooth region according to an embodiment of the present disclosure;

FIG. 8 depicts an exemplary general image having a false contour caused by compression;

FIG. 9 depicts an exemplary image of a false contour candidate map with M₁(p) resulting from performing Step 1 on the image of FIG. 8 according to an embodiment of the present disclosure;

FIG. 10 depicts an exemplary image of a false contour candidate map with M₂(p) resulting from performing Step 2 on the image of FIG. 8 according to an embodiment of the present disclosure;

FIG. 11 depicts an exemplary image of a false contour candidate map with M₃(p) resulting from performing Step 3 on the image of FIG. 8 according to an embodiment of the present disclosure;

FIG. 12 is a view depicting two exemplary windows to which dithering is applied according to an embodiment of the present disclosure; and

FIG. 13 is a view depicting an exemplary method or implementing an apparatus for false contour detection and removal according to an embodiment of the present disclosure.

### DETAILED DESCRIPTION

Certain embodiments of the present disclosure will be described below in detail with reference to exemplary drawings. It is to be noted that like reference numerals denote the same components although in different drawings. In addition, a known structure or function will not be described in detail lest it should obscure the subject matter of the present disclosure.

Terms such as first, second, A, B, (a), or (b) may be used in describing components according to embodiments of the present disclosure. These terms are used merely to distinguish one component from another component, not limiting the substantial property, sequence, or order of the components. Unless otherwise defined, the terms and words including technical or scientific terms used in the following description and claims may have the same meanings as generally understood by those skilled in the art. The terms as generally defined in dictionaries may be interpreted as having the same or similar meanings as or to contextual meanings of related technology. Unless otherwise defined, the terms should not be interpreted as ideally or excessively formal meanings. When needed, even the terms as defined in the present disclosure may not be interpreted as excluding embodiments of the present disclosure.

First, terms used in the following description of the present disclosure will be described below.

False contour: an artifact that does not exist in an uncompressed original video but is produced due to compression (quantization). The false contour is a contour-like pattern perceived on an image display screen. The term ‘pseudo contour’ is used in the same sense as false contour.

Real contour: a contour-like pattern perceived also in an uncompressed original video on an image display screen. The real contour is observed mainly in an edge region and a texture region of a video object.

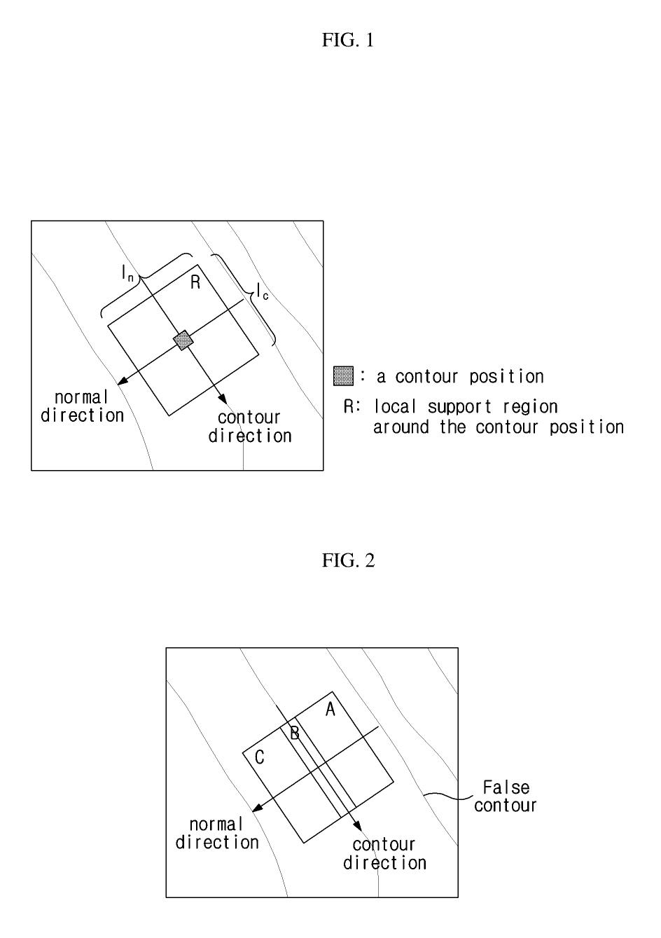

Local support region: a square area comprised of pixels adjacent to a current pixel, used for acquiring information with which to determine whether the current pixel is on a false contour. As illustrated in FIG. 1, the horizontal direction of a local support region R is a contour direction, and the vertical direction of the local support region R is a direction perpendicular to a contour, that is, a normal direction. A horizontal-direction pixel size I_{c} and a vertical-direction pixel size Iₙ may be predefined.

Profile: a graph of the pixel values of pixels existing in a contour direction with respect to a selected contour candidate pixel, or a graph of the pixel values of pixels existing in a normal direction with respect to the selected contour candidate pixel.

False contour map: a map of values mapped to the positions of pixels in one video frame. In general, the false contour map has as many pixels as the size of an image (one to one mapping). The pixel values of the map are generally binary values. If a pixel value is 1, this means that a pixel corresponding to the pixel value is on a false contour (i.e., a false contour candidate), and if a pixel value is 0, this means that the pixel corresponding to the pixel value is not on a false contour. If pixel p is a false contour candidate, its pixel value is expressed as M(p) set to 1, and otherwise, its pixel value is expressed as M(p) set to 0.

Evolution of false contour map: a false contour map is obtained in a plurality of steps, not at one time in a false contour detection method of the present disclosure. As the procedure progresses, more constraints are imposed. Thus, the number of false contour candidates is decreased, that is, the accuracy of false contour candidates is increased. This operation is referred to as evolution of a false contour map. The value of M(p) resulting from Step k is expressed as Mₖ(p).

A false contour is dominantly observed in a High Efficiency Video Coding (HEVC) compressed video. This is because compared to Advanced Video Coding (AVC), new coding tools for effectively suppressing a blocking artifact, a ringing artifact, and so on are added to HEVC, thus greatly reducing other artifacts, whereas a tool for suppressing a false contour artifact is not added to HEVC. Although the number of coded bits may be increased to avoid false contour artifacts, this method is not effective. For example, even in the case where a High Definition (HD) video is encoded at a high bit rate (e.g., using a Quantization Parameter (QP) of 12) and viewed on an about 60-inch large display, a false contour artifact may still be observed. In other words, the false contour problem may not be solved perfectly just with an increased bit rate.

Quantization during encoding is the cause of a false contour. A false contour is not generated in all regions of an image, confined to a smooth region satisfying a special condition. The special condition is that a pixel value monotonically increases or decrease in a region. The false contour is generated in a direction perpendicular to a monotonic increase/decrease direction. In the case of a color image, a false contour is affected only by the luminance component of a pixel value. Hereinafter, a pixel value means only a luminance component value in the present disclosure.

Therefore, if the condition of monotonic increase/decrease of pixel values in a smooth region is not maintained, a false contour may not be generated. If the smooth region is subject to quantization, the smooth region is divided into a plurality of regions having the same/similar pixel values, and the boundary between the regions form a false contour. The false contour may or may not be visually perceived according to the width of each region. If the region is too narrow, the false contour is not perceived, and if the width of the region is equal to or larger than a specific value, one false contour is perceived. If the width of the region becomes larger, false contours are perceived at both boundaries of the region, that is, two false contours are perceived.

Since the width of a region is affected by a QP, there is a range of QPs in which a false contour is visually perceived well. With use of a low QP (a high bit rate), the width of each region is small and the difference between the values of regions is narrow, thus making it difficult to perceive a false contour. At a high QP (a low bit rate), other artifacts such as blocking and ringing are more dominant, thus rendering a false contour to be relatively unperceivable.

It may be determined whether a current pixel is on a false contour, based on information of a local support region R. The local support region R is a square region spanning in a contour direction and a normal direction, with a current pixel at the center. Hereinbelow, a horizontal direction in the local support region R refers to a contour direction, and a vertical direction in the local support region R refers to a normal direction, in the present disclosure.

For the presence of a false contour, the condition of monotonic increase or decrease of pixel values in a smooth region should be satisfied. Thus, it may be determined whether a current pixel is on a false contour, based on the condition. In an embodiment of the false contour determination method, the local support region R illustrated in FIG. 1 may be divided into three regions A, B, and C as illustrated in FIG. 2. Then, an average pixel value of each region may be calculated, and it may be determined whether a current pixel is on a false contour by checking whether the average pixel value Avg(B) of region B is similar to the intermediate value of the average pixel value Avg(A) of region A and the average pixel value Avg(C) of region C.

That is, if a pixel satisfies [Equation 1], the pixel may be determined to be on a false contour. A threshold Th₁ is determined according to the resolution of an image, a display size, a viewing distance, and so on.

−Th₁<Avg(B)−½(Avg(A)+Avg(C))<Th₁ [Equation 1]

In an embodiment of another false contour determination method, since the average pixel value Avg(B) of region B is the intermediate value of the average pixel value Avg(A) of region A and the average pixel value Avg(C) of region C, the difference between the average pixel value Avg(B) of region B and the average pixel value Avg(A) of region A, and the difference between the average pixel value Avg(B) of region B and the average pixel value Avg(C) of region C should have different signs. That is, if a pixel satisfies [Equation 2], the pixel may be determined to be on a false contour.

(Avg(B)−Avg(A))×(Avg(B)−Avg(C))<0 [Equation 2]

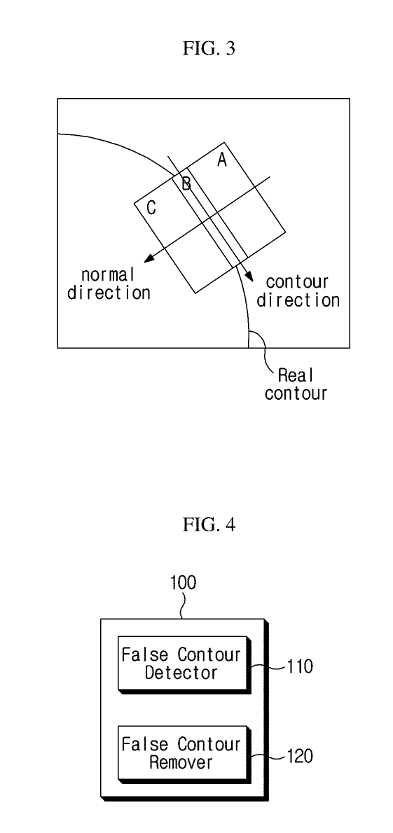

The condition of [Equation 1] or [Equation 2] is not established for a real contour observed mainly in an edge or texture, as illustrated in FIG. 3.

FIG. 4 is a block diagram of an apparatus 100 for false contour detection and removal according to an embodiment of the present disclosure.

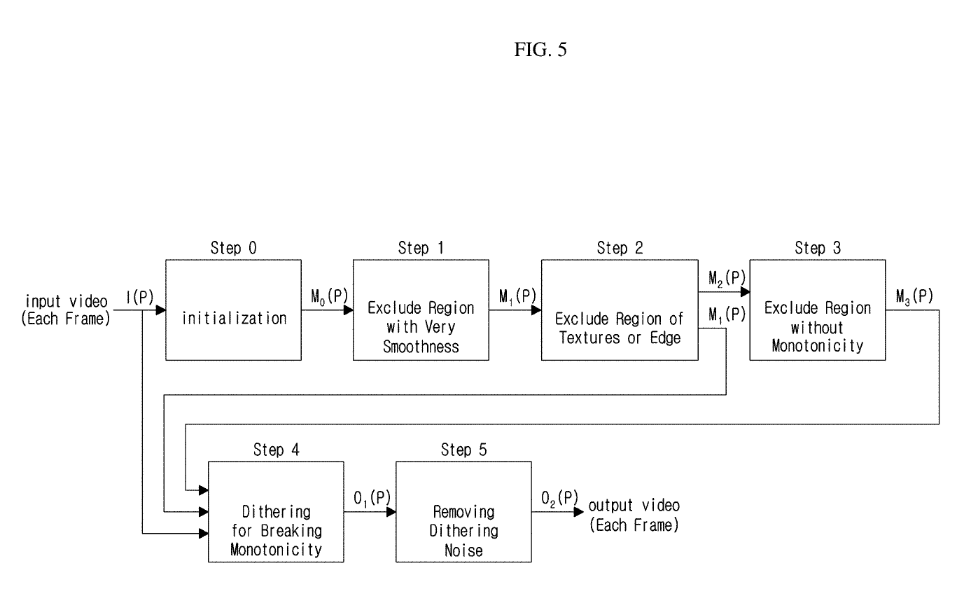

Referring to FIG. 4, the apparatus 100 for false contour detection and removal according to an embodiment of the present disclosure may be provided in a video decoder, and includes a false contour detector 110 and a false contour remover 120 in order to perform a post-process for detecting and removing a false contour. The components of the apparatus 100 for false contour detection and removal may be implemented in hardware such as a semiconductor processor, software such as an application program, or a combination of hardware and software. With reference to FIG. 5, an operation of the apparatus 100 for false contour detection and removal will be described below.

FIG. 5 is a view depicting an operation of the apparatus 100 for false contour detection and removal according to an embodiment of the present disclosure.

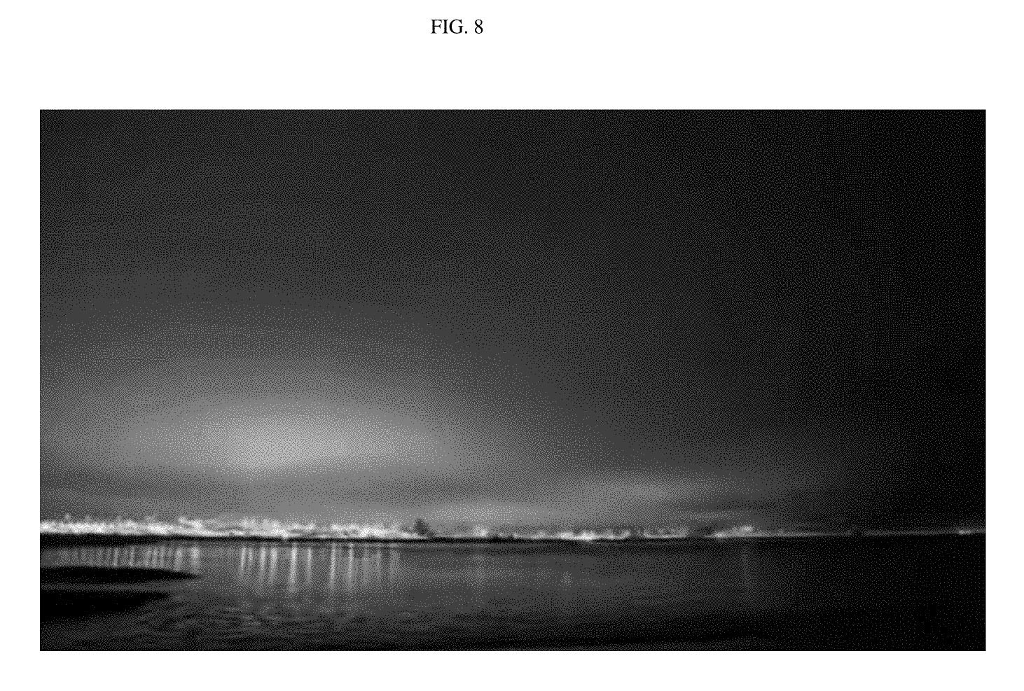

Referring to FIG. 5, the false contour detector 110 performs initialization (Step 0), exclusion of a very smooth region (Step 1), exclusion of a texture or edge region (Step 2), and exclusion of a region without monotonicity (Step 3), for an input image (refer to FIG. 8). The false contour remover 120 performs dithering for breaking monotonicity (Step 4) and removal of dithering noise (Step 5).

Now, a detailed description will be given of false contour detection.

A False Contour Candidate Map (FCCM) results from false contour detection. The pixels of the FCCM are mapped to the pixels of an input image in a one-to-one correspondence. It is possible to configure the FCCM in a smaller size than the input image. In this case, the pixels of the FCCM are mapped to the pixels of the input image in a one-to-multi correspondence. For example, if an FCCM is configured in ½ of the width of an input image by ½ of the length of the input image, one pixel of the FCCM is mapped to four pixels of the input image.

An embodiment of an FCCM with as many pixels as the number of pixels in an input image will be described. Each pixel of the FCCM indicates whether a pixel of the input image corresponding to the pixel is on a false contour. In general, the pixel values of the FCCM are binary values. If a pixel value is 1, this means that a pixel corresponding to the pixel value is on a false contour (i.e., a false contour candidate), and if a pixel value is 0, this means that a pixel corresponding to the pixel value is not on a false contour. If pixel p is a false contour candidate, its pixel value is expressed as M(p) set to 1, and otherwise, its pixel value is expressed as M(p) set to 0.

As the procedure progresses from Step 0 to Step 2, the FCCM evolves, and is confirmed as a false contour map in Step 3. A false contour map in the middle of the procedure is an FCCM. In each Step k, the value of M(p) is expressed as Mₖ(P).

The false contour detector 110 performs a false contour detection procedure in three steps, Step 1 to Step 3 after initialization of an input image in Step 0, as illustrated in FIG. 4. The output result of each step is an FCCM, and the FCCM is used as an input to the next step.

Each step is performed only on pixels determined to be false contour candidate pixels in the previous step. Accordingly, as the procedure progresses, the number of false contour candidate pixels is decreased, and the accuracy of determining false contour candidate pixels is increased. To represent this feature, the false contour detection procedure proposed by the present disclosure is referred to as false contour detection based on evolution of a false contour map. Although a plurality of steps are involved in the proposed evolution of a false contour map, only pixels valid until the previous step are subject to an additional detection operation. Therefore, computation complexity is significantly reduced.

The false contour detector 110 performs initialization (Step 0), exclusion of a very smooth region (Step 1), exclusion of a texture or edge region (Step 2), and exclusion of a region without monotonicity (Step 3), on an input image (refer to FIG. 8).

In the initialization step, Step 0, the false contour detector 110 generates and outputs an FCCM with M₀(P)=1 as pixel mapping values for all pixels p of an input image (refer to FIG. 8), assuming that all pixels of the input image are false contour candidates (pixels on a false contour), for the data of each frame of the input image, as expressed as [Equation 3].

M₀(p)=1, for All p [Equation 3]

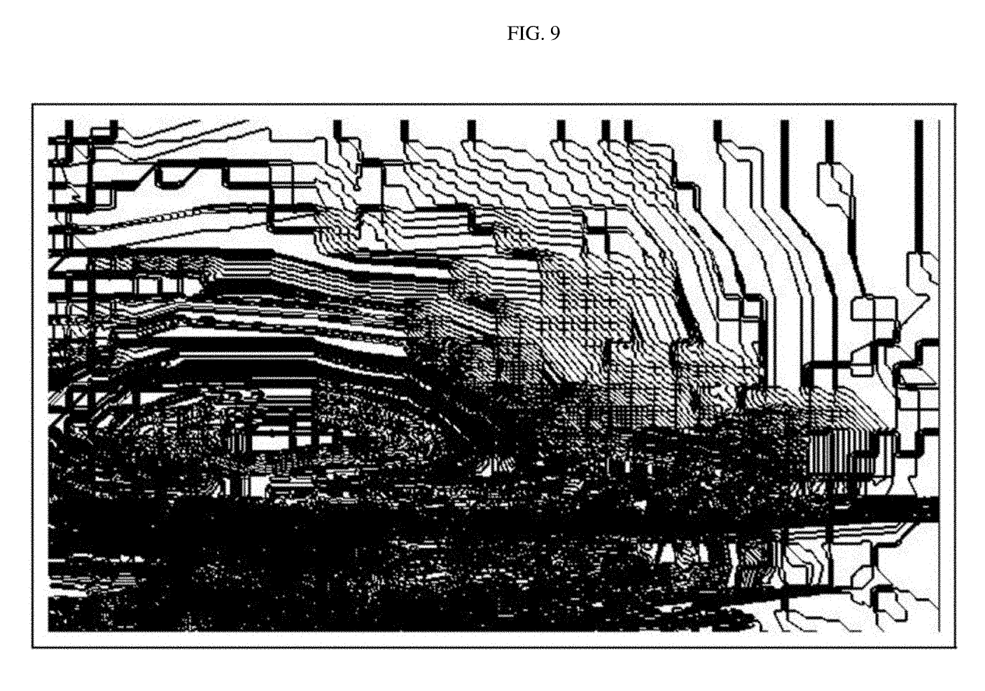

In the exclusion of a very smooth region step, Step 1, the false contour detector 110 calculates pixel gradient values of all pixels p with M₀(p)=1 with respect to their adjacent pixels according to M₀(p) resulting from Step 0, and generates and outputs an FCCM with M₁(p) as pixel mapping values in order to exclude the pixels of a very smooth region. That is, M₁(p) set to 0 is output for the pixels of the very smooth region, and M₁(p) set to 1 is output for the pixels of the other regions. FIG. 9 illustrates an exemplary image of an FCCM with M₁(p) resulting from performing Step 1 on the image of FIG. 8.

As described above, a false contour is generated in a region having pixel gradient values equal to or larger than a predetermined value, that is, a smooth region with a monotonic increase/decrease of pixel values. Therefore, since a very smooth region with a very small pixel gradient value has the same value after quantization, that is, the very smooth region does not have the monotonic increase/decrease property, a false contour does not occur in the very smooth region. In other words, a very smooth region may not be a false contour candidate and thus such pixels are excluded from the FCCM.

The false contour detector 110 may determine for every pixel p whether a pixel is in a very smooth region by calculating pixel gradient values of the pixel with respect to its adjacent pixels by [Equation 4] and [Equation 5].

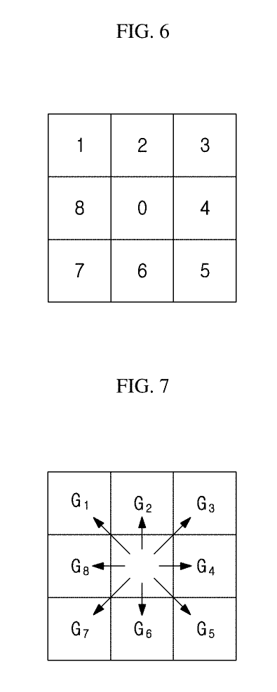

FIG. 6 is a view depicting the position of a current pixel, pixel 0 and the positions of adjacent pixels, pixel 1 to pixel 8 surrounding the current pixel, pixel 0, for use in identifying a very smooth region according to an embodiment of the present disclosure.

For example, the false contour detector 110 may calculate four pixel value differences Gₘ(p), that is, G₁(p), G₂(p), G₃(p), and G₄(p) between the current pixel (p=0) and adjacent pixels in the directions of m={1,2,3,4} by [Equation 4] and four pixel value differences Gₘ*(p), that is, G₅(p), G₆(p), G₇(p), and G₈(p) between the current pixel (p=0) and adjacent pixels in the opposite directions of m*={5,6,7,8} by [Equation 4].

FIG. 7 is a view depicting a current pixel and adjacent pixel pairs for use in identifying a very smooth region according to an embodiment of the present disclosure.

For example, as illustrated in FIG. 7, the false contour detector 110 may calculate pixel gradient values G_{m,m*}(p) of the current pixel (p=0) with respect to adjacent pixel pairs (m, m*)={(1,5), (2,6), (3,7), (4,8)} by adding Gₘ(p) and G_{m*}(p) by [Equation 5].

Gₘ(p)=|Iₘ(p)−I₀(p)|

G_{m*}(p)=|I_{m*}(p)−I₀(p)| [Equation 4]

G_{m,m*}(p)=Gₘ(p)+G_{m*}(p) [Equation 5]

The false contour detector 110 may calculate pixel gradient values G_{m,m*}(p) of each pixel p with respect to adjacent pixel pairs (m, m*) by [Equation 4] and [Equation 5] in the above manner, determine the pixel p to be in a very smooth region if all of the pixel gradient values are equal to or less than a predetermined threshold, and generate an FCCM with M₁(p)=1 only for pixels in a region other than the very smooth region.

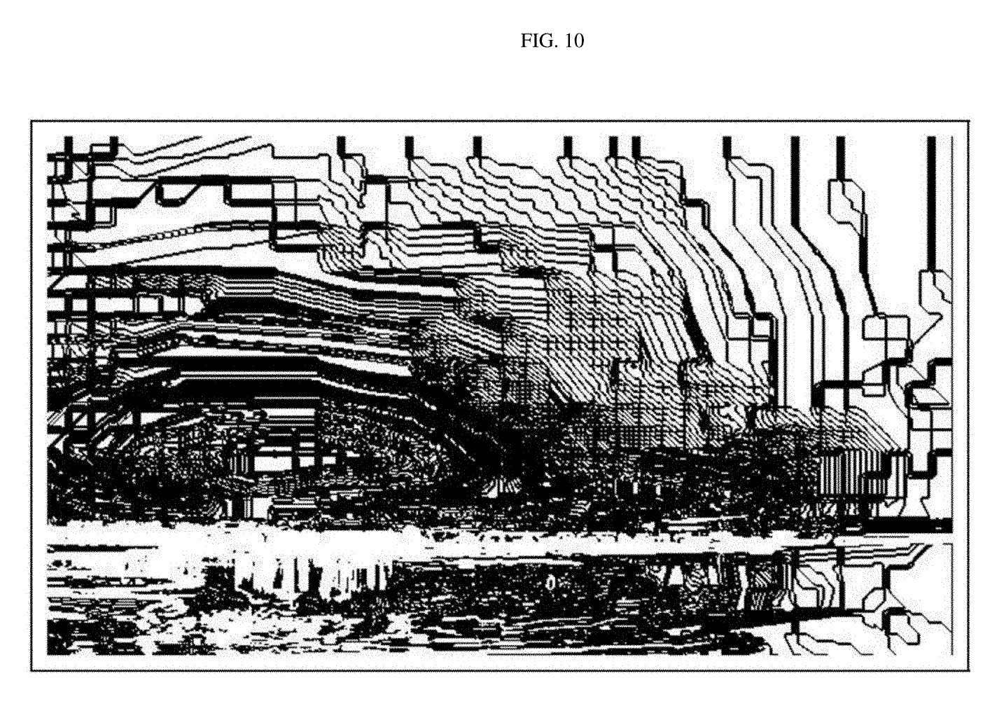

In the exclusion of a texture or edge region step, Step 2, the false contour detector 110 generates and outputs an FCCN with M₂(p) as pixel mapping values by determining whether pixel p with M₁(p) in the input image is in a texture or edge region using the above-calculated pixel gradient values G_{m,m*}(p) for the adjacent pixel pairs (m, m*), according to M₁(p) resulting from the exclusion of a very smooth region step, Step 1, so that the pixels of the texture or edge region may be excluded. That is, M₂(p) set to 0 is output for the pixels of the texture or edge region, and M₂(p) set to 1 is output for the pixels of a region other than the texture or edge region. A texture/edge map with Mₜ(p) set to 1 as the pixel mapping value of the texture/edge region is also generated and output. This step is performed only for the pixels with M₁(p) set to 1, and it is determined whether each of the pixels with M₁(p) set to 1 is in a texture-complex region or an edge region. If a pixel is in the texture-complex region or the edge region, the pixel is excluded from candidates. FIG. 10 illustrates an exemplary image corresponding to the FCCM with M₂(p) resulting from performing Step 2 on the image of FIG. 8.

It is very difficult to perceive a false contour generated in a texture-complex region because of one of the human visual features, visual masking. The visual masking effect occurs mainly in a texture-complex region. In consideration of the visual masking effect, the texture-complex region is excluded from false contour candidates. Further, since an edge corresponds to a real contour, the edge is also excluded from false contour candidates so that the edge may be distinguished from a false contour.

For example, if both of [Equation 6] and [Equation 7] are satisfied for pixels with M₁(p) set to 1, the false contour detector 110 determines that the pixels are in a texture or edge region which should be removed, determines M₂(p) and Mₜ(p) to be 0 and 1, respectively for the pixels, generates and outputs an FCCM with M₂(p) as pixel mapping values to thereby exclude the pixels of the texture/edge region, and a texture/edge map with Mₜ(p) set to 1 as the pixel mapping values of the texture/edge region. Herein, the above-calculated pixel gradient values G_{m,m*}(p) with respect to the adjacent pixel pairs (m, m*)={(1,5), (2,6), (3,7), (4,8)} are used as in [Equation 6] and [Equation 7]. If the maximum of the pixel gradient values G_{m,m*}(p) is larger than Th₃ and the sum of the pixel gradient values G_{m,m*}(p) is larger than Th₄, it is determined that the pixel is in a texture or edge region.

Max{G_{1,5}(p),G_{2,6}(p),G_{3,7}(p),G_{4,8}(p)}>Th₃ [Equation 6]

G_{1,5}(p)+G_{2,6}(p)+G_{3,7}(p)+G_{4,8}(p)>Th₄ [Equation 7]

That is, the false contour detector 110 calculates pixel gradient values G_{m,m*}(p) by summing the differences between a target pixel and pixel values at both sides of the target pixel on the same line, with respect to a plurality of directions (e.g., four directions) from the target pixel. If the maximum of the pixel gradient values G_{m,m*}(p) in the plurality of directions is larger than the threshold Th₃, and the sum of the pixel gradient values G_{m,m*}(p) is larger than the threshold Th₄, it is determined that the pixel is in a texture or edge region.

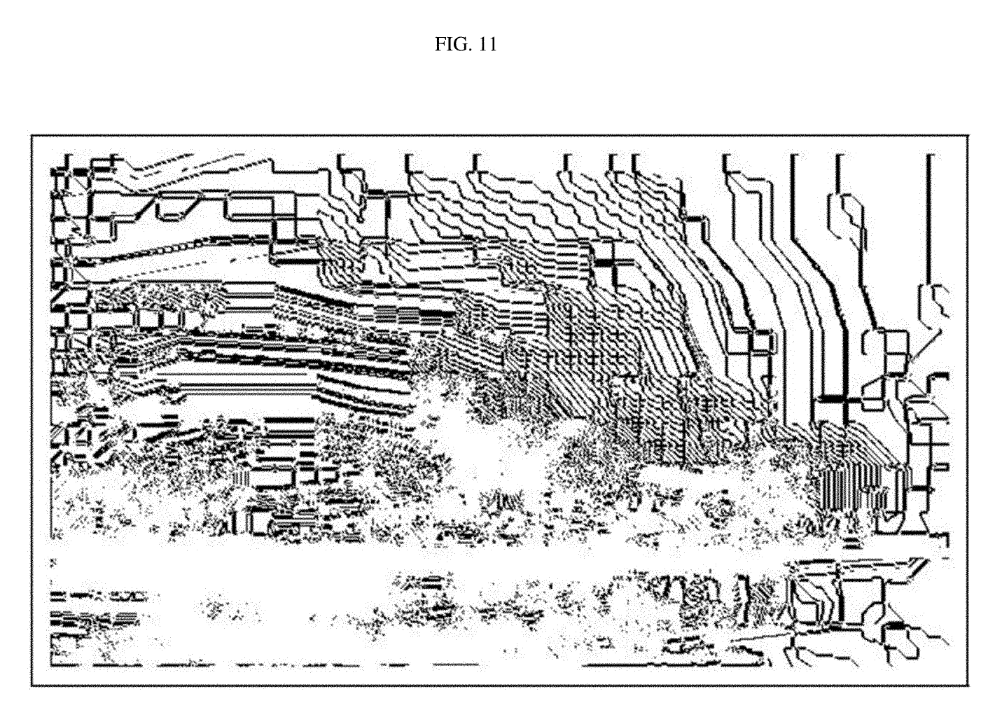

In the exclusion of a region without monotonicity step, Step 3, the false contour detector 110 determines for pixel p with M₂(p) set to 1 in the input image, according to M₂(p) resulting from Step 2 whether the pixel is at a position experiencing a monotonic pixel value increase/decrease, and generates and outputs an FCCM with M₃(p) as pixel mapping values so that the pixels of a region without monotonicity may be excluded. That is, M₃(p) set to 0 is output for a pixel in a region without monotonicity, and M₃(p) set to 1 is output for a pixel in a region with a monotonic increase/decrease of pixel values. FIG. 11 illustrates an exemplary image of an FCCM with M₃(p) resulting from performing Step 3 on the image of FIG. 8.

Since a false contour is generated in a smooth region with a monotonic increase/decrease, a region without monotonicity is excluded from the FCCM, as described before.

To identify a region without monotonicity, the false contour detector 110 determines monotonicity in the contour direction and the normal direction with respect to a pixel p with M₂(p) set to 1.

For example, if both conditions expressed in [Equation 8] and [Equation 9] are satisfied for the pixel p with M₂(p) set to 1, the false contour detector 110 determines M₃(p) to be 0 for the pixel p, considering that the pixel p is in a region without monotonicity, and generates and outputs an FCCM with M₃(p) as pixel mapping values, so that the pixels of the region without monotonicity may be excluded. N₃(p) is the number of adjacent pixel pairs having the same pixel gradient value along the contour direction, and Nₙ(p) is the number of adjacent pixel pairs having the same pixel gradient value along the normal direction.

N_{c}(p)<Th₅ [Equation 8]

Nₙ(p)<Th₆ [Equation 9]

That is, for adjacent pixels of a pixel p with M₂(p) set to 1, the false contour detector 110 determines gradient value continuity of adjacent pixel pairs (current pixel, first adjacent pixel), (first adjacent pixel, second adjacent pixel), . . . . If the number N_{c}(p) of adjacent pixel pairs having the same pixel gradient value in the contour direction is smaller than a threshold Th₄, and the number Nₙ(p) of adjacent pixel pairs having the same pixel gradient value in the normal direction is smaller than the threshold Th₅, the false contour detector 110 determines that the pixel is in a region without monotonicity.

Now, a detailed description will be given of false contour removal.

In a conventional false contour removal method, since false contour detection information is not accurate, particularly a false contour and a real contour are not distinguished from each other, a part other than a false contour is also subject to a removal operation, thereby additionally generating other artifacts. In contrast, in the false contour removal method of the present disclosure, false contour information is accurately detected and processed in two steps (Step 4 and Step 5) to remove additional artifacts that may be generated during the removal operation, as illustrated in FIG. 4. Especially, since a real contour (textures and edges) is preserved, the false contour removal method of the present disclosure outperforms the conventional false contour removal method.

The false contour remover 120 performs dithering for breaking monotonicity (Step 4) and dithering noise removal (Step 5).

In the dithering for breaking monotonicity step, Step 4, the false contour remover 120 generates and outputs an image O₁(p) without monotonicity by probabilistic dithering in which values within a window including pixels in a false contour direction or a normal direction perpendicular to the false contour direction (the pixel values of pixels other than textures/edges) are replaced with a value selected randomly from the pixel values of pixels other than texture/edge pixels from among pixels p with M₃(p) set to 1 in the input image I(p), based on the texture/edge map with Mₜ(p) set to 1 as pixel mapping values of the texture/edge region, resulting from Step 2, and the FCCM with M₃(p) as pixel mapping values, configured to thereby exclude the pixels of a region without monotonicity, resulting from Step 3.

As described before, since a false contour is generated only in a smooth region with a monotonic increase/decrease, if monotonicity is not maintained around the false contour, the false contour may be removed, that is, may not be visually perceived. For this purpose, dithering which increases randomness may be used around the false contour. In an embodiment of dithering according to the present disclosure, probabilistic dithering is used, which reflects a distribution of adjacent pixel values. Non-monotonic pixels to which dithering is not applied are reflected immediately as pixels of the output image O₁(p) (if M₃(p)=0, O₁(p)=I(p)). The pixels of a monotonic part to which dithering is applied are reflected in the output image O₁(p) after dithering.

The false contour remover 120 performs probabilistic dithering only on false contour candidate pixels with M₃(p) set to 1. Herein, dithering is applied to the pixel values of the input image I(p). That is, the values of an FCCM are used only as false contour position information.

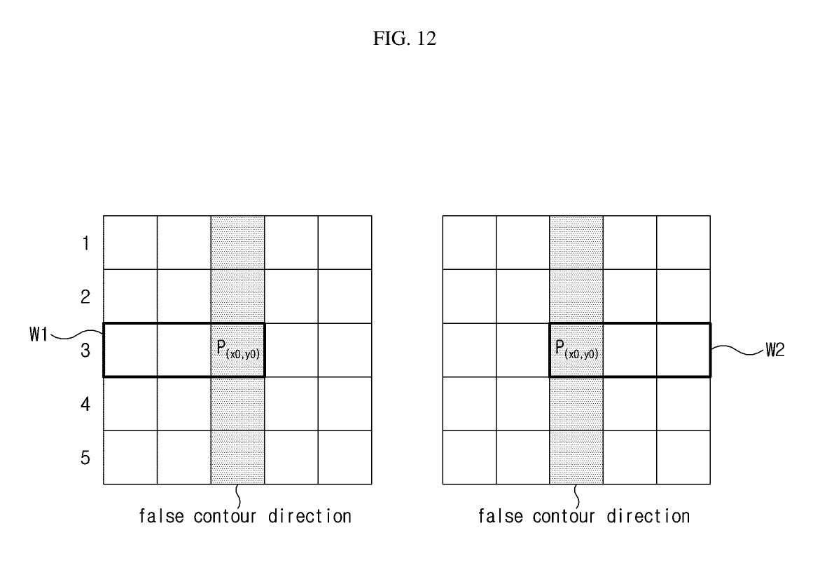

FIG. 12 is an exemplary view depicting two windows to which dithering is applied according to an embodiment of the present disclosure.

First, the false contour remover 120 determines a first window W1 (i={0, 1, 2, . . . , L−1}) and a second window W2[i] (i={0, 1, 2, . . . , L−1}) a target pixel being a false contour candidate pixel p(x₀, y₀). The first window W1[i] includes at least one pixel located in a first normal direction on a basis of the target pixel, and the second window W2[i] includes at least one pixel located in a second normal direction on a basis of the target pixel, wherein the second normal direction is opposite direction of the first normal direction. While the directions of the windows W1 an W2 are perpendicular to each other with respect to the false contour direction, both the windows W1 and W2 are shown in FIG. 12 as directed vertically for L=5, for the convenience of description. The reason for performing probabilistic dithering for each of the two windows W1 and W2 is that if probabilistic dithering is performed at one time using a single window, other artifacts may be produced. For the convenience of description, an embodiment will be described in the context of the pixels of a false contour being included in both windows. However, since the pixels of a false contour may be included only in one window, probabilistic dithering may be applied to one of the two windows W1 and W2, under circumstances.

While the following description is given of a probabilistic dithering method in the context of processing the first window W1, by way of example, the second window W2 may also be processed in the same manner

For probabilistic dithering, the false contour remover 120 may generate a one-dimensional pixel array P1 by excluding texture and edge pixels from the pixels (i=0 to L) of the window W1, based on the texture/edge map with Mₜ(p) set to as the pixel mapping values of the texture/edge region. For example, as the pseudo code of the following [Algorithm 1] describes, it is determined for the L sequential pixels of the window W1 whether a pixel is a texture/edge pixel. If a pixel p is not a texture/edge pixel (Mₜ(p)=0), the pixel value of the pixel p is added to the pixel array P1 (P1[j]=W1[i]). This operation is repeated for the L pixels, and the pixel array P1 is finally stored in a storage means, along with the size W of the pixel array P1 equal to the number of pixels stored in P1.

[Algorithm 1]
j=0;
For i=0, i<L, i++
Determine whether pixel p corresponding to W1[i] is texture/edge.
If the pixel p is not texture/edge (Mₜ(p)=0), it is added to the array P1 (P1[j]=W1[i]).
Increase the index j of the array P1; j++
Write the size of the array P1; W=j

Subsequently, the false contour remover 120 processes all pixel values W1[i] of the window W1. Notably, the false contour remover 120 replaces the pixel values of pixels other than texture/edge pixels with a pixel value randomly selected from the pixel array P1. For example, as the pseudo code of [Algorithm 2] describes, the false contour remover 120 sequentially determines whether each of the L pixels of the window W1 is a texture/edge pixel, and does not change the pixel values of pixels corresponding to textures/edges. The false contour remover 120 repeats an operation for generating a random value r within the size W of the array P1 and changing a current pixel value W1[i] to P1[r] (W1[i]=P1[r]), for the pixels corresponding to textures/edges. According to this operation, the false contour remover 120 may generate and output an image without monotonicity, O₁(p)=W1[i].

[Algorithm 2]
For i=0, i<L, i++
Determine whether pixel p corresponding to W1[i] is texture/edge.
If Mₜ(p)=1, that is, the pixel p is texture/edge, the current pixel value is not changed; i.e., Continue
If Mₜ(p)=0, a random value r is generated; r=Round(W×Random (0,1)), and r is an integer.
The current pixel value W1 is changed using the generated random value r; W1[i]=P1[r],
Reflect the pixel value W1[i] resulting from dithering in an output image; O₁(p)=W1

The distribution of the pixel values of adjacent pixels in the window is reflected in the array P1 used in the above operation. As more adjacent pixels have the same value, they are more probable to be selected and reflected in W1[i]. The above operation is referred to as probabilistic dithering in consideration of this property, in the present disclosure.

Then, in the dithering noise removal step, Step 5, the false contour remover 120 generates and outputs a final output image O₂(p) by removing dithering noise only from the dithered pixels in the output image O₁(p) resulting from the dithering for breaking monotonicity, Step 4.

Because dithering increases randomness in the dithering for breaking monotonicity, Step 4, random noise may be generated. An embodiment of the present disclosure will be described in the context of averaging filtering among various types of filtering effective for random noise removal.

The false contour remover 120 removes dithering noise by applying averaging filtering only to the dithered pixels. That is, the false contour remover 120 applies averaging filtering to false contour candidate pixels (M₃(p)=1) using the pixel values of the pixels of the two windows W1 and W2 for the pixels. Since dithering was not applied to the pixels corresponding to texture/edge candidates (Mₜ(p)=1), these pixels are not subject to noise removal.

First, the false contour remover 120 acquires the pixel values of the pixels of the windows W1 and W2 among L×L (e.g., L=5) window areas with respect to a target pixel (a dithered pixel) in the image O₁(p). The false contour remover 120 calculates an average value M by dividing the acquired pixel values of the pixels of the windows W1 and W2 by the number of pixels in the windows, (L×L), replaces the pixel values with the average value M, and reflects the average value M in the output image O₂(p) (O₂(p)=M). Notably, only when the difference between the pixel value O₁(p) of the target pixel and the average value O₂(p) (=M) is equal to or less than a threshold Th₆ as described in [Equation 10], the pixel value is replaced. Pixels that do not satisfy [Equation 10] are just reflected in the output image O₂(p).

−Th₇<O₂(p)−O₁(p)<Th₇ [Equation 10]

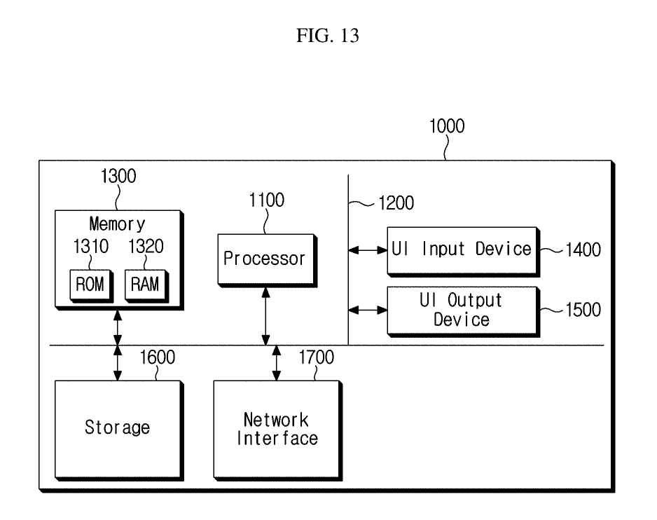

FIG. 13 depicts an exemplary method for implementing the apparatus 100 for false contour detection and removal according to an embodiment of the present disclosure. The apparatus 100 for false contour detection and removal according to an embodiment of the present disclosure may be configured in hardware, software, or a combination of both. For example, the apparatus 100 for false contour detection and removal may be configured as a computing system 1000 illustrated in FIG. 13.

The computing system 1000 may include at least one processor 1100, a memory 1300, a User Interface (UI) input device 1400, a UI output device 1500, a storage 1600, and a network interface 1700, which are interconnected through a bus 1200. The processor 1100 may be a semiconductor device that executes commands stored in a Central Processing Unit (CPU) or the memory 1300, and/or the storage 1600. The memory 1300 and the storage 1600 may include various types of volatile or non-volatile storage media. For example, the memory 1300 may include a Read Only Memory (ROM) 1310 and a Random Access Memory (RAM) 1320.

Accordingly, the steps of the methods or algorithms as described in relation to the embodiments of the present disclosure may be performed in a hardware module, a software module, or a combination of both by the processor 1100. The software module may reside in a storage medium (i.e., the memory 1300 and/or the storage 1600) such as a RAM, a flash memory, a ROM, an Erasable, Programmable ROM (EPROM), an Electrically Erasable, Programmable ROM (EEPROM), a register, a hard disk, a detachable disk, or a Compact Disk-ROM (CD-ROM). The exemplary storage medium may be coupled to the processor 1100, and the processor 1100 may read information from the storage medium and write information to the storage medium. In another method, the storage medium may be integrated with the processor 1100. The processor 1100 and the storage medium may reside in an Application Specific Integrated Circuit (ASIC). The ASIC may be provided in a user terminal. In another method, the processor 1100 and the storage medium may be provided as individual components in the user terminal.

As described above, the apparatus 100 for false contour detection and removal according to the present disclosure detects the position of a false contour based on features of a human visual system (high smoothness, textures/edges, monotonicity, etc.) in a post-process during video decoding. Notably, the apparatus 100 for false contour detection and removal applies the features sequentially, not at one time by evolution of a false contour map, to thereby increase accuracy. Further, a false contour is removed by a visual masking effect without using low-pass filtering. For the false contour removal, probabilistic dithering is applied, and averaging filtering is additionally applied to a dithered part to remove random noise generated during the probabilistic dithering. Accordingly, the position of a false contour is accurately detected, and the false contour is removed based on the detected position, while details of a video itself are not damaged. As a consequence, when a compressed video is viewed, a video perception quality can be improved greatly.

While the present disclosure has been described and illustrated herein with reference to the exemplary embodiments thereof, it will be apparent to those skilled in the art that various modifications and variations can be made therein without departing from the spirit and scope of the invention.

The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

1. A method for processing a false contour in a video-compressed image processing apparatus, the method comprising:
performing false contour detection by detecting a map of false contour candidate pixels from input image data through sequential evolution of a step of acquiring false contour candidate pixels based on each of a plurality of features of a human visual system in a manner that decreases the number of pixels to be detected in each sequential step; and
performing false contour removal by removing a false contour in the input image data according to the map of false contour candidate pixels.

2. The method according to claim 1, wherein the false contour detection sequentially comprises removal of a very smooth region, exclusion of a texture and edge region, and exclusion of a region without monotonicity.

3. The method according to claim 1, wherein the false contour detection comprises:
calculating pixel gradient values of each pixel of the input image data with respect to predetermined adjacent pixels around the pixel, and determining a very smooth region based on the pixel gradient values; and
generating a first False Contour Candidate Map (FCCM) having pixel mapping values to exclude pixels of the very smooth region.

4. The method according to claim 3, wherein the false contour detection further comprises:
calculating pixel gradient values of pixels of a region other than the very smooth region with respect to predetermined adjacent pixels around the pixels, using the first FCCM, and determining whether the region is a texture or edge region based on the pixel gradient values; and
generating a second FCCM having pixel mapping values to exclude pixels of the texture or edge region.

5. The method according to claim 4, wherein the calculation and determination comprises:
calculating pixel gradient values by adding differences between a pixel value of a target pixel and pixel values at both sides of the target pixel in the same line in a plurality of directions; and
if a maximum of the pixel gradient values in the plurality of directions is larger than a threshold, and a sum of the pixel gradient values is larger than a threshold, determining that the region is a texture or edge region.

6. The method according to claim 4, wherein the false contour detection further comprises:
determining for each of pixels of a region other than the texture or edge region whether the pixel is at a position with a monotonic increase or decrease of pixel values, using the second FCCM; and
generating a third FCCM having pixel mapping values to exclude pixels of a region without monotonicity.

7. The method according to claim 6, wherein the determination comprises, if the number of adjacent pixel pairs having the same pixel gradient value with respect to a target pixel along a contour direction is less than a first threshold, and the number of adjacent pixel pairs having the same pixel gradient value with respect to the target pixel along a normal direction perpendicular to the contour direction is less than a second threshold, determining that the target pixel is in the region without monotonicity.

8. The method according to claim 1, wherein the false contour removal comprises removing monotonicity by probabilistic dithering of pixels of a region with monotonicity generated during the false contour detection.

9. The method according to claim 8, wherein the false contour removal comprises generating video data without dithering noise by applying averaging filtering only to the dithered pixels in image data without monotonicity.

10. The method according to claim 8, wherein for each of the pixels of the region with monotonicity in the input image data, values within a first window i or values within a second window are replaced with a value selected randomly from pixel values of pixels that do not belong to a texture or edge among the pixels of the region with monotonicity, during the probabilistic dithering,
wherein the first window includes at least one pixel located in a first normal direction on a basis of a target pixel, and the second window includes at least one pixel located in a second normal direction on the basis of the target pixel, wherein the second normal direction is opposite direction of the first normal direction.

11. An apparatus for processing a false contour in a video-compressed image, the apparatus comprising:
a false contour detector for detecting a map of false contour candidate pixels from input image data through sequential evolution of a step of acquiring false contour candidate pixels based on each of a plurality of features of a human visual system in a manner that decreases the number of pixels to be detected in each sequential step; and
a false contour remover for removing a false contour in the input image data according to the map of false contour candidate pixels.

12. The apparatus according to claim 11, wherein the false contour detector sequentially performs removal of a very smooth region, exclusion of a texture and edge region, and exclusion of a region without monotonicity.

13. The apparatus according to claim 11, wherein the false contour detector calculates pixel gradient values of each pixel of the input image data with respect to predetermined adjacent pixels around the pixel, determines a very smooth region based on the pixel gradient values, and generates a first False Contour Candidate Map (FCCM) having pixel mapping values to exclude pixels of the very smooth region.

14. The apparatus according to claim 13, wherein the false contour detector calculates pixel gradient values of pixels of a region other than the very smooth region with respect to predetermined adjacent pixels around the pixels, using the first FCCM, determines whether the region is a texture or edge region based on the pixel gradient values, and generates a second FCCM having pixel mapping values to exclude pixels of the texture or edge region.

15. The apparatus according to claim 14, wherein the false contour detector calculates pixel gradient values by adding differences between a pixel value of a target pixel and pixel values at both sides of the target pixel in the same line in a plurality of directions, and if a maximum of the pixel gradient values in the plurality of directions is larger than a threshold, and a sum of the pixel gradient values is larger than a threshold, determines that the region is a texture or edge region.

16. The apparatus according to claim 14, wherein the false contour detector determines for each of pixels of a region other than the texture or edge region whether the pixel is at a position with a monotonic increase or decrease of pixel values, using the second FCCM, and generates a third FCCM having pixel mapping values to exclude pixels of a region without monotonicity.

17. The apparatus according to claim 16, wherein when the false contour detector determines whether the pixel is at a position with a monotonic increase or decrease of pixel values, if the number of adjacent pixel pairs having the same pixel gradient value with respect to a target pixel along a contour direction is less than a first threshold, and the number of adjacent pixel pairs having the same pixel gradient value with respect to the target pixel along a normal direction perpendicular to the contour direction is less than a second threshold, the false contour detector determines that the target pixel is in the region without monotonicity.

18. The apparatus according to claim 11, wherein the false contour remover removes monotonicity by probabilistic dithering of pixels of a region with monotonicity generated during the false contour detection.

19. The apparatus according to claim 18, wherein the false contour remover generates video data without dithering noise by applying averaging filtering only to the dithered pixels in image data without monotonicity.

20. The apparatus according to claim 18, wherein for each of the pixels of the region with monotonicity in the input image data, the false contour remover replaces values within a first window or values within a second window with a value selected randomly from pixel values of pixels that do not belong to a texture or edge among the pixels of the region with monotonicity, during the probabilistic dithering,
wherein the first window includes at least one pixel located in a first normal direction on a basis of a target pixel, and the second window includes at least one pixel located in a second normal direction on the basis of the target pixel, wherein the second normal direction is opposite direction of the first normal direction.
